(19) United States
(12) Patent Application Publication
(10) Pub. No.: US 2015/0278996 A1
(43) Pub. Date: Oct. 1, 2015

(54) IMAGE PROCESSING APPARATUS, METHOD, AND MEDIUM FOR GENERATING COLOR IMAGE DATA

(71) Applicant: CANON KABUSHIKI KAISHA, Tokyo (JP)

(72) Inventor: Shohei Tsutsumi, Yokohama-shi (JP)

(21) Appl. No.: 14/673,681

(22) Filed: Mar. 30, 2015

(30) Foreign Application Priority Data
Mar. 31, 2014 (JP) 2014-074571

(51) Int. Cl. G06T 3/40; H04N 13/02; H04N 13/00

(52) U.S. Cl. CPC G06T 3/4038; H04N 13/0037; H04N 13/004; H04N 13/0239; H04N 13/0257; G06T 2200/32; G06T 2200/04

(57) ABSTRACT

An image processing apparatus includes a first acquisition unit configured to acquire color image data including chromaticity information of an object, a second acquisition unit configured to acquire monochrome image data including brightness information of the object, and a generation unit configured to align and combine the color image data and the monochrome image data, thereby generating composite image data, which is image data in color and higher in resolution quality than the color image data, wherein the generation unit generates the composite image data such that a pixel value of each pixel in the composite image data includes chromaticity information based on the color image data and brightness information based on the monochrome image data.

### BACKGROUND OF THE INVENTION

1. Field of the Invention

The present disclosure generally relates to a technique for generating color image data with a high resolution quality and with little noise and, more particularly, to an image processing apparatus, imaging apparatus, image processing method, and medium.

2. Description of the Related Art

In recent years, there is a growing demand for a technique for measuring three-dimensional data of an object and displaying the object in a stereoscopically visible manner using color three-dimensional image data obtained by combining a color image of the object and the measured values. One of the methods for acquiring three-dimensional data of an object is the method for using a plurality of images that have been captured by a monochrome (black-and-white) stereo camera and have a parallax, and performing a stereo matching process based on the correlation between the images. In this method, to improve the measurement accuracy of the three-dimensional data of the object, the method for acquiring the three-dimensional data of the object using three or more images (parallax images) having different viewpoints is known.

Further, in addition to three-dimensional data of an object, a technique for combining a color image of an object captured by a color camera and three-dimensional data of the object obtained by stereo matching, thereby generating color three-dimensional image data of the object is discussed (see the specification of Japanese Patent No. 4193292).

In the technique discussed in the specification of Japanese Patent No. 4193292, an imaging apparatus for obtaining parallax images is a stereo camera including a single monochrome camera and a single color camera. The specification of Japanese Patent No. 4193292 discusses the following technique. A color image C acquired by the color camera is converted into a monochrome image GA, and then, three-dimensional data of an object is measured by performing a stereo matching process using a monochrome image GB acquired by the monochrome camera and the monochrome image GA. Then, the measured three-dimensional data of the object and the color image C are associated together, thereby generating color three-dimensional image data of the object.

Further, a technique for setting a color image capture area and monochrome image capture areas together on an image sensor of a single imaging apparatus and generating color three-dimensional image data of an object is discussed (see the publication of Japanese Patent Application Laid-Open No. 2009-284188). The imaging apparatus discussed in the publication of Japanese Patent Application Laid-Open No. 2009-284188 is configured such that a lens array is placed on the near side of the image sensor on the optical axis of the imaging apparatus, thereby generating images different in viewpoint using a single imaging apparatus. In the technique discussed in the publication of Japanese Patent Application Laid-Open No. 2009-284188, three-dimensional data of an object is acquired from image data obtained from the plurality of monochrome image capture areas set on the image sensor of the imaging apparatus, and a color image of the object is acquired from the color image capture area set on the same image sensor. Then, the three-dimensional data and the color image of the object are combined together, thereby generating color three-dimensional image data of the object.

In the techniques discussed in the specification of Japanese Patent No. 4193292 and the publication of Japanese Patent Application Laid-Open No. 2009-284188, luminance information used for three-dimensional data of an object is luminance information of a color image acquired by a color camera (the color image capture area in the publication of Japanese Patent Application Laid-Open No. 2009-284188). This makes generated noise more likely to be noticeable in the color image than in a monochrome image obtained by a monochrome camera (the monochrome image capture areas in the publication of Japanese Patent Application Laid-Open No. 2009-284188). Further, the color image is subjected to a demosaic process for calculating, by an interpolation process, color information of a pixel of interest from a plurality of pixels having different pieces of chromaticity information and located near the pixel of interest. This makes the resolution quality of the color image lower than that of the monochrome image.

### SUMMARY OF THE INVENTION

According to an aspect of the present disclosure, an image processing apparatus includes a first acquisition unit configured to acquire color image data including chromaticity information of an object, a second acquisition unit configured to acquire monochrome image data including brightness information of the object, and a generation unit configured to align and combine the color image data and the monochrome image data, thereby generating composite image data, which is image data in color and higher in resolution quality than the color image data, wherein the generation unit generates the composite image data such that a pixel value of each pixel in the composite image data includes chromaticity information based on the color image data and brightness information based on the monochrome image data.

Further features of the present disclosure will become apparent from the following description of exemplary embodiments with reference to the attached drawings.

### BRIEF DESCRIPTION OF THE DRAWINGS

FIG. 1 is a diagram illustrating an example of a stereo imaging apparatus including two image capture units.

FIG. 2 is a block diagram illustrating the configuration of an imaging apparatus according to a first exemplary embodiment.

FIGS. 3A, 3B, and 3C are diagrams illustrating the details of image capture units.

FIG. 4 is a block diagram illustrating the internal configuration of an image processing unit according to the first exemplary embodiment and a second exemplary embodiment.

FIG. 5 is a flow chart illustrating the flow of the processing performed by the image processing unit according to the first and second exemplary embodiments.

FIG. 6 is a diagram schematically illustrating the process of generating color image data.

FIG. 7 is a block diagram illustrating the internal configuration of an image processing unit according to third and fourth exemplary embodiments.

FIG. 8 is a flow chart illustrating the flow of the processing performed by the image processing unit according to the third exemplary embodiment.

FIG. 9 is a diagram illustrating examples of a multi-lens imaging apparatus including a plurality of image capture units.

FIG. 10 is a flow chart illustrating the flow of the processing performed by the image processing unit according to the fourth exemplary embodiment.

FIG. 11 is a block diagram illustrating the internal configuration of an image processing unit according to a fifth exemplary embodiment.

FIG. 12 is a flow chart illustrating the flow of the processing performed by the image processing unit according to the fifth exemplary embodiment.

FIGS. 13A and 13B are diagrams schematically illustrating the process of searching for corresponding points.

### DESCRIPTION OF THE EMBODIMENTS

Exemplary embodiments of the present disclosure will be described in detail below with reference to the drawings. In the figures, similar components are designated by the same numerals, and redundant description is omitted.

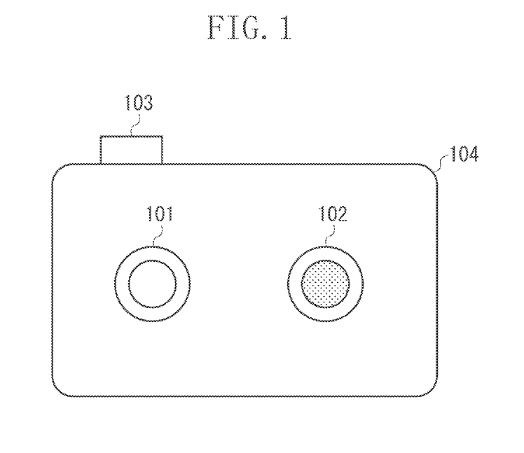

A first exemplary embodiment is described. FIG. 1 illustrates a stereo imaging apparatus including two image capture units according to the first exemplary embodiment of the present disclosure. In FIG. 1, a color image capture unit 101 acquires a color image. A monochrome image capture unit 102 acquires a monochrome image. The details of the color image capture unit 101 and the monochrome image capture unit 102 will be described later. FIG. 1 exemplifies a photographing button 103 and a housing 104 of the imaging apparatus. The arrangement of the image capture units is not limited to the configuration of FIG. 1. The color image capture unit 101 and the monochrome image capture unit 102 may be arranged in a line in a vertical direction or may be arranged in a line in an oblique direction. As used herein, the term “unit” generally refers to any combination of software, firmware, hardware, or other component, such as circuitry, that is used to effectuate a purpose.

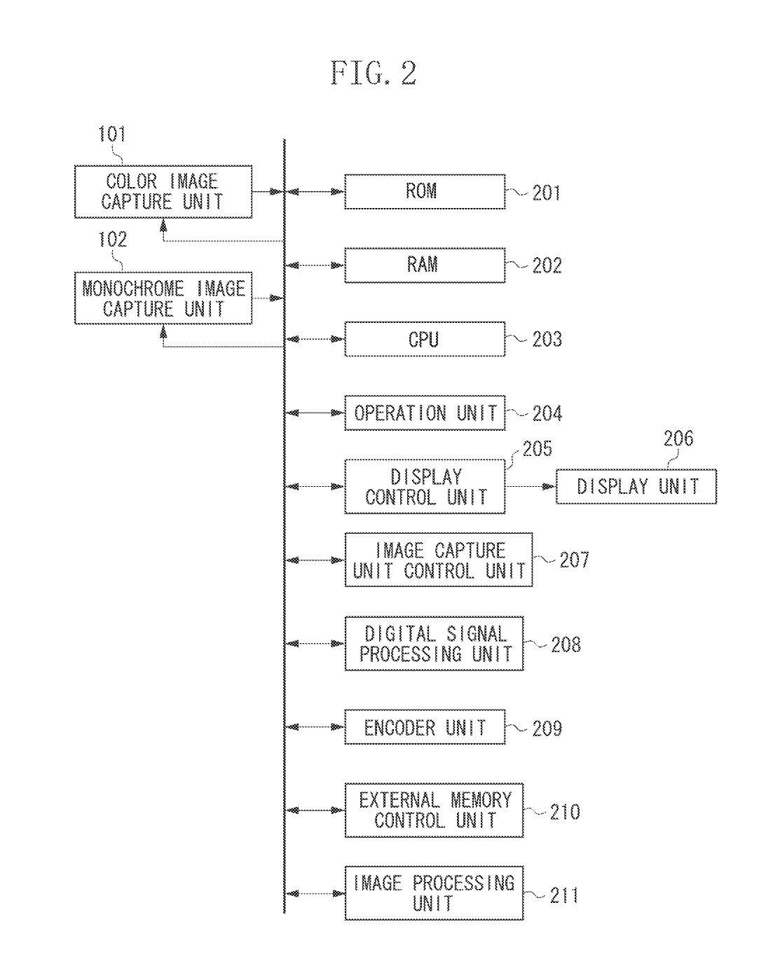

FIG. 2 illustrates processing units included in the stereo imaging apparatus in FIG. 1. Each of the color image capture unit 101 and the monochrome image capture unit 102 receives optical information of an object using a sensor (an image sensor), performs analog-to-digital (A/D) conversion on an analog signal output from the sensor, and then outputs digital data to a bus 212, which is a data transfer path.

A central processing unit (CPU) 203 is involved in all types of processing of components. The CPU 203 sequentially reads commands stored in a read-only memory (ROM) 201 and a random-access memory (RAM) 202, interprets the commands, and performs processing according to the results of the interpretation. Further, the ROM 201 and the RAM 202 provide the CPU 203 with a program, data, and a work area that are required for the processing.

An operation unit 204 includes buttons and a mode dial. The operation unit 204 receives an input user instruction and outputs the user instruction to the bus 212. An image capture unit control unit 207 controls an imaging system as instructed by the CPU 203, such as focusing, opening a shutter, and adjusting a diaphragm.

A digital signal processing unit 208 performs a white balance process, a gamma process, and a noise reduction process on digital data supplied from the bus 212, thereby generating a digital image. An encoder unit 209 converts the digital data into a Joint Photographic Experts Group (JPEG) file format or a Moving Picture Experts Group (MPEG) file format.

An external memory control unit 210 is an interface for connecting the imaging apparatus to a personal computer (PC) or a medium (e.g., a hard disk, a memory card, a CompactFlash (CF) card, a Secure Digital (SD) card, or a Universal Serial Bus (USB) memory).

Generally, a liquid crystal display is widely used as a display unit 206. The display unit 206 displays a photographed image received from an image processing unit 211, which will be described below, and characters. Further, the display unit 206 may have a touch screen function. In this case, a user instruction input through the display unit 206 can also be treated as an input through the operation unit 204. A display control unit 205 controls the display of the photographed image and the characters displayed on the display unit 206.

The image processing unit 211 performs image processing on a digital image obtained from each of the image capture units 101 and 102 or a group of digital images output from the digital signal processing unit 208, and outputs the result of the image processing to the bus 212. The components of the apparatus can be configured differently from the above by combining the components to have equivalent functions. The imaging apparatus according to the present disclosure is characterized by the image capture units 101 and 102 and the image processing unit 211.

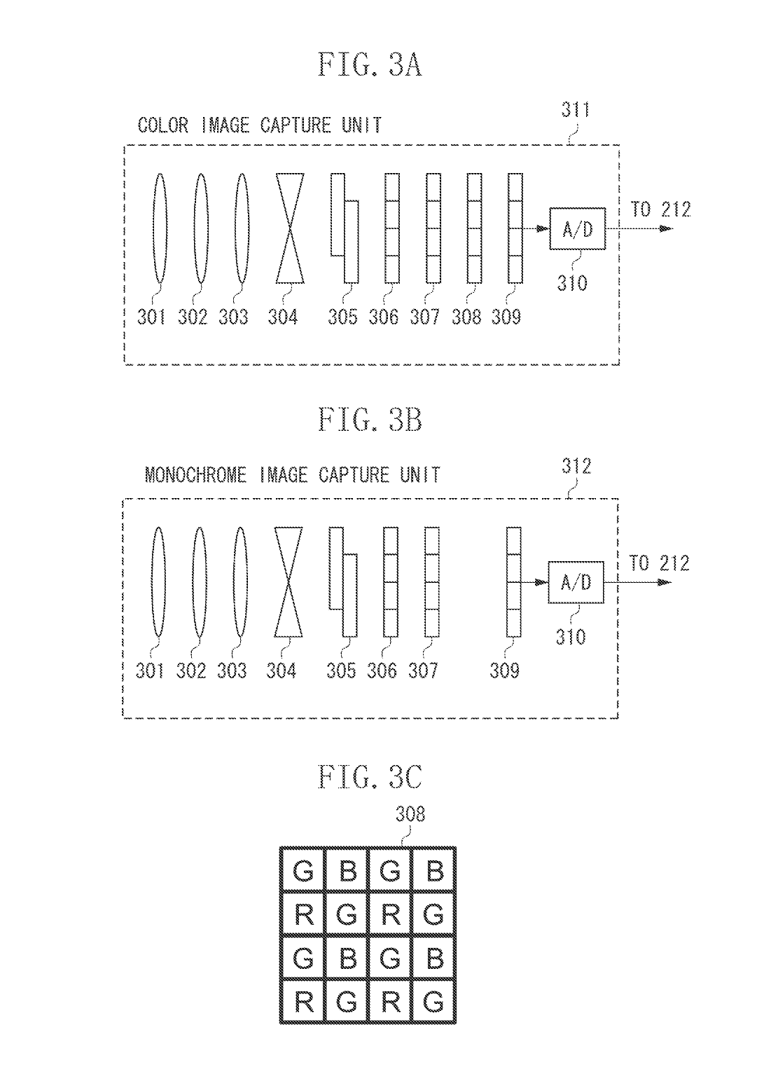

Next, with reference to FIGS. 3A to 3C, the details of the image capture units 101 and 102 are described. A color image capture unit 311 illustrated in FIG. 3A represents the specific configuration of the color image capture unit 101.

The color image capture unit 311 includes a zoom lens 301, a focus lens 302, a blur correction lens 303, a diaphragm 304, a shutter 305, an optical low-pass filter 306, an infrared (IR) cut filter 307, color filters 308, a sensor 309, and an A/D conversion unit 310. The color filters 308 detect color information of red (R), blue (B), and green (G). This enables the color image capture unit 311 to acquire color image data indicating chromaticity information of an object. FIG. 3C illustrates an example of the arrangement of the color filters 308. The color filters 308 are configured to have the Bayer arrangement, where filters for detecting chromaticity information of any of RGB for respective pixels are regularly arranged. The arrangement of the color filters 308 is not limited to the Bayer arrangement, and the present disclosure is applicable to various arrangement systems. The color image capture unit 311 detects the amount of light of the object using the components 301 to 309. Then, the A/D conversion unit 310 converts the detected amount of light of the object into a digital value. The configuration of a monochrome image capture unit 312 illustrated in FIG. 3B is obtained by removing the color filters 308 from the color image capture unit 311. The monochrome image capture unit 312 detects the amount of light, particularly luminance information, of the object. The information to be detected by the monochrome image capture unit 312 is not limited to luminance information. The monochrome image capture unit 312 may be configured to detect lightness information so long as the information is brightness information indicating the brightness of the object.

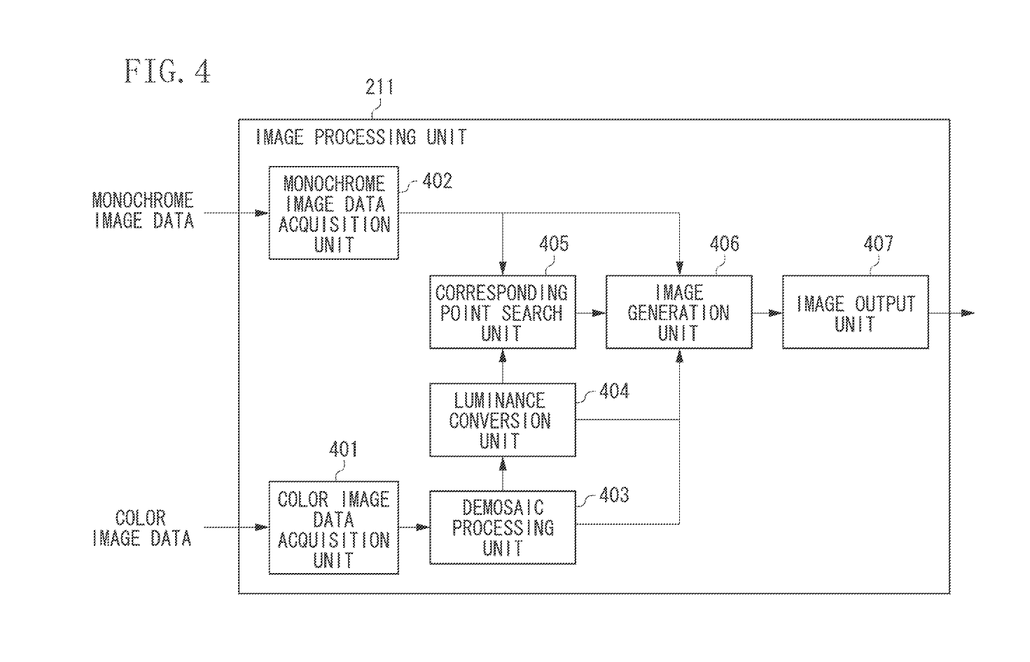

FIG. 4 is a block diagram illustrating the configuration of the image processing unit 211 illustrated in FIG. 2. The image processing unit 211 includes a color image data acquisition unit 401, a monochrome image data acquisition unit 402, a demosaic processing unit 403, a luminance conversion unit 404, a corresponding point search unit 405, an image generation unit 406, and an image output unit 407.

The color image data acquisition unit 401 acquires color image data supplied from the color image capture unit 101 via the bus 212. The monochrome image data acquisition unit 402 acquires monochrome image data supplied from the monochrome image capture unit 102 via the bus 212. Using the image data supplied from the color image data acquisition unit 401, the demosaic processing unit 403 generates color image data of which chromaticity information at each pixel position has been interpolated by an interpolation process (a demosaic process). Specifically, the demosaic processing unit 403 generates RGB image data of an object. The “RGB image data” specifically means color image data in which each pixel has three pixel values of R, G, and B. In the color image data before being subjected to the demosaic process, each pixel has only the pixel value of any one of R, G, and B.

The luminance conversion unit 404 converts the color image data supplied from the demosaic processing unit 403 into luminance image data. Specifically, the luminance conversion unit 404 converts the pixel values of the RGB image data of the object into YCbCr values, extracts a luminance value Y from among the YCbCr values to obtain luminance image data Y, and outputs the luminance image data Y. The corresponding point search unit 405 searches for a corresponding point at each pixel position in the luminance image data Y supplied from the luminance conversion unit 404 and luminance image data of the monochrome image data. The image generation unit 406 generates new color image data using groups of corresponding points supplied from the corresponding point search unit 405, the color image data supplied from the demosaic processing unit 403 and the luminance conversion unit 404, and the monochrome image data supplied from the monochrome image data acquisition unit 402. The image output unit 407 outputs the color image data generated by the image generation unit 406. Each processing unit is controlled by the CPU 203.

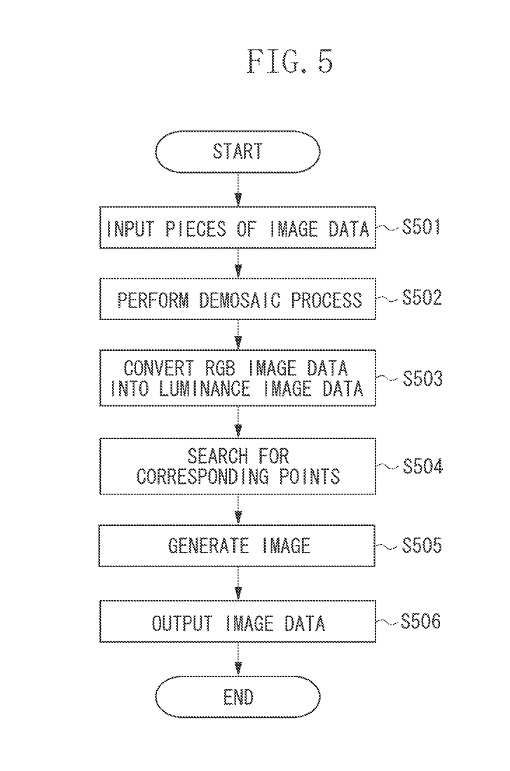

Next, with reference to a flow chart in FIG. 5, an image processing method performed by the image processing unit 211 is described. First, in step S501, the color image data acquisition unit 401 inputs color image data captured by the color image capture unit 101, and the monochrome image data acquisition unit 402 inputs monochrome image data captured by the monochrome image capture unit 102. In the present exemplary embodiment, a single piece of color image data Ic(i,j), which has been captured by the color image capture unit 101, and a single piece of monochrome image data Ig(i,j), which has been captured by the monochrome image capture unit 102, are input. In this case, (i,j) represents the pixel position of a pixel of interest in each piece of image data.

Next, in step S502, using the image data supplied from the color image data acquisition unit 401, the demosaic processing unit 403 generates color image data of which chromaticity information at each pixel position has been interpolated by an interpolation process (a demosaic process). Specifically, the demosaic processing unit 403 generates RGB image data RGB(i,j) (referred to as “first color image data” in the present exemplary embodiment) of an object from the color image data Ic(i,j).

Next, in step S503, the luminance conversion unit 404 generates luminance image data Yc using the color image data RGB(i,j) supplied from the demosaic processing unit 403. Specifically, the luminance conversion unit 404 converts the pixel values of the RGB image data RGB(i,j) of the object into YCbCr values, extracts a luminance value Y to obtain luminance image data Yc(i,j), and outputs the luminance image data Yc(i,j). Further, the digital signal processing unit 208 generates luminance image data Yg(i,j) (referred to as “first luminance image data” in the present exemplary embodiment) by extracting a luminance value Y from the monochrome image data Ig(i,j) supplied from the monochrome image data acquisition unit 402.

Next, in step S504, the corresponding point search unit 405 searches for a corresponding point at each pixel position in the luminance image data Yc(i,j) of the color image data and the luminance image data Yg(i,j) of the monochrome image data. That is, the corresponding point search unit 405 compares the luminance image data Yc with the luminance image data Yg, thereby determining groups of corresponding pixels corresponding to the same object position between the color image data and the monochrome image data. That is, the corresponding point search unit 405 aligns the color image data and the monochrome image data. As the method for searching for corresponding points, a general pattern matching technique such as a stereo matching method is used. In the present exemplary embodiment, the luminance image data Yc(i,j) of the color image data is defined as a reference image, thereby searching for a pixel position (x(i),y(j)), which is included in the monochrome image data and corresponds to a pixel position (i,j) in the color image data.

Next, in step S505, based on the relationships between the corresponding points supplied from the corresponding point search unit 405, the image generation unit 406 generates new color image data R′G′B′(i,j) (referred to as “second color image data” in the present exemplary embodiment). In the first exemplary embodiment, the image generation unit 406 converts the value of the luminance image data Yc(i,j) of the color image data into new luminance image data Yc′(i,j) (referred to as “second luminance image data” in the present exemplary embodiment) using formula (1).

Yc′(i,j)=Yg(x(i),y(j)) (1)

In formula (1), the corresponding point (x(i),y(j)) in the monochrome image data may be a real number. In this case, the image generation unit 406 performs an interpolation process using luminance data Yg near the pixel of interest, thereby obtaining luminance data Yg(x(i),y(j)) at the corresponding pixel position.

The image generation unit 406 generates second color image data R′G′B′(i,j) using the luminance image data Yc′(i,j), which has been obtained by formula (1), and chromaticity values CbCr(i,j) of the color image data, which have been derived by the luminance conversion unit 404. That is, at this time, the color image data and the monochrome image data are combined together, whereby it is possible to generate composite image data in which each pixel includes chromaticity information of the color image data and brightness information of the monochrome image data.

Finally, in step S506, the image output unit 407 outputs the newly generated second color image data R′G′B′(i,j). Thus, the image processing performed by the image processing unit 211 is completed.

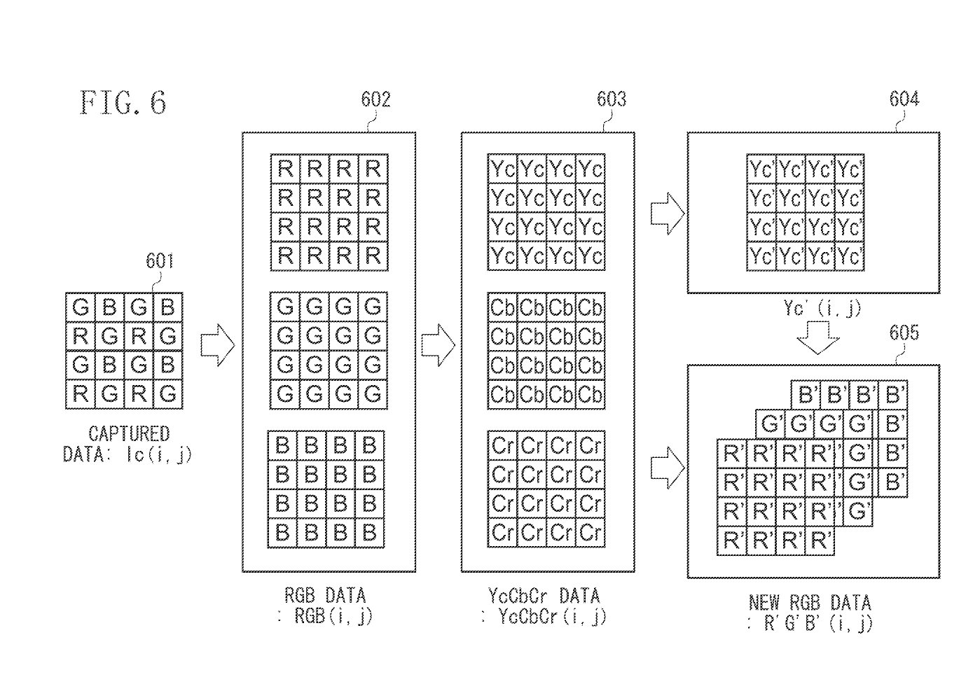

FIG. 6 is a diagram schematically illustrating the process of generating second color image data, which is generated by the image generation unit 406. Captured data 601 is image data Ic(i,j), which is supplied from the color image data acquisition unit 401. First color image data RGB(i,j), which is color image data 602 of an object, is obtained by performing a demosaic process on the image data Ic(i,j). Next, YcCbCr(i,j), which is image data 603 obtained by converting the color image data 602 into the YCbCr color space, is derived by calculations. Next, second luminance image data Yc′(i,j), which is luminance data 604 of the color image data 602, is obtained using first luminance image data Yg(i,j), which is luminance image data of monochrome image data. Finally, second color image data R′G′B′(i,j), which is new color image data 605, is generated using the second luminance image data Yc′(i,j) and CbCr(i,j) of the first color image data RGB(i,j).

The imaging apparatus according to the present exemplary embodiment searches for a pixel position (x(i),y(j)), which is included in monochrome image data and corresponds to each pixel position (i,j) in color image data, generates color image data viewed from the viewpoint position of a color image capture unit, and outputs the generated color image data. Alternatively, the imaging apparatus may search for a pixel position (xx(i),yy(j)), which is included in color image data and corresponds to each pixel position (i,j) in monochrome image data, generate color image data viewed from the viewpoint position of a monochrome image capture unit, and output the generated color image data. In this case, the imaging apparatus adds CbCr(xx(i),yy(j)), which is chromaticity information of the color image data, to luminance information Yg(i,j) of the monochrome image data, converts the YCbCr values into RGB image data, and then outputs the RGB image data.

Further, in the present exemplary embodiment, color image data may be generated from all the viewpoint positions of a color image capture unit and a monochrome image capture unit, and the generated color image data may be output. Alternatively, color image data may be generated from only some of the viewpoint positions, and the generated color image data may be output. Further, in addition to the color image data generated by the image generation unit 406, part or all of the monochrome image data acquired by the monochrome image data acquisition unit 402 and the color image data acquired by the color image data acquisition unit 401 may be output.

Further, in the present exemplary embodiment, color image data and monochrome image data are converted into luminance image data (Y values), and then, corresponding points between the images are obtained. Alternatively, corresponding points may be obtained using information other than luminance information. For example, color image data and monochrome image data may be converted into brightness values in CIELAB (L* values), and then, corresponding points may be obtained. Similarly, chromaticity information of color image data used to generate second color image data is not limited to CbCr values. Alternatively, UV values in the YUV color space may be used, or a*b* values in the CIELAB color space may be used.

As described above, according to the present exemplary embodiment, a stereo imaging apparatus including a color image capture unit and a monochrome image capture unit can obtain color image data with a high resolution quality and with little noise.

In the present exemplary embodiment, the color image data acquisition unit 401 functions as a first acquisition unit configured to acquire color image data including chromaticity information of an object. Further, the monochrome image data acquisition unit 402 functions as a second acquisition unit configured to acquire monochrome image data including brightness information of the object. Further, the corresponding point search unit 405 functions as a determination unit configured to determine groups of corresponding pixels, which are groups of pixels corresponding to the same object position as each other, between the color image data and the monochrome image data. Further, the image generation unit 406 functions as a generation unit configured to generate composite image data obtained by combining the color image data and the monochrome image data based on the groups of corresponding pixels determined by the determination unit.

A second exemplary embodiment is described. In the first exemplary embodiment, a form has been described in which corresponding points of color image data and monochrome image data are searched for, and luminance information of the color image data is converted using luminance information of the monochrome image data, thereby generating new color image data. Next, in the second exemplary embodiment, a form has been described in which luminance data of color image data to be generated by the image generation unit 406 is generated using both luminance information of color image data and luminance information of monochrome image data. In the following, points specific to the present exemplary embodiment are mainly described. According to the present exemplary embodiment, more information is used for generating a pixel value, whereby it is possible to further reduce the amount of noise.

An imaging apparatus according to the present exemplary embodiment uses luminance image data Yc(i,j), which is obtained from color image data, and luminance image data Yg(i,j), which is obtained from monochrome image data, thereby converting the luminance image data Yc(i,j) into second luminance image data Yc′(i,j). The second luminance image data Yc′(i,j) is represented using the following formula.

Yc′(i,j)=(Yc(i,j)+Yg(x(i),y(j)))/2 (2)

Formula (2) represents the average value of the pixel value of the luminance image data Yc of the color image data and the pixel value of the luminance image data Yg of the monochrome image data at a corresponding pixel position.

According to the present exemplary embodiment, luminance information of color image data to be newly generated is generated using both luminance information of color image data and luminance information of monochrome image data, whereby it is possible to generate color image data in which noise is further suppressed.

Further, the luminance image data Yc′(i,j), which is newly generated, may be the weighted average value of the luminance image data Yc(i,j) and the luminance image data Yg(i,j) as represented by formula (3), instead of the average value of the luminance values represented by formula (2).

Yc′(i,j)=w×Yc(i,j)+(1−w)×Yg(x(i),y(j)) (3)

In formula (3), w represents the weight coefficient of the luminance image data Yc of the color image data. A weighted average value using a weight coefficient is thus employed, whereby it is possible to generate color image data having a suitable amount of noise, taking into account the amount of noise of color image data and the amount of noise of monochrome image data.

The imaging apparatus according to the present exemplary embodiment searches for a pixel position (x(i),y(j)), which is included in monochrome image data and corresponds to each pixel position (i,j) in color image data, generates color image data viewed from the viewpoint position of a color image capture unit, and outputs the generated color image data. Alternatively, the imaging apparatus may search for a pixel position included in color image data and corresponding to each pixel position (i,j) in monochrome image data, generate color image data viewed from the viewpoint position of a monochrome image capture unit, and output the generated color image data. As described above, according to the present exemplary embodiment, luminance information of composite image data is generated using both luminance information of color image data and luminance information of monochrome image data, whereby it is possible to obtain color image data in which noise is further suppressed.

A third exemplary embodiment is described. In the second exemplary embodiment, a form has been described in which luminance data of color image data to be generated by the image generation unit 406 is generated using both luminance information of color image data and luminance information of monochrome image data. According to the second exemplary embodiment, it is possible to reduce noise compared with the case of using only the luminance information of the monochrome image data. However, simultaneously, the resolution quality becomes lower compared with the case of using only the luminance information of the monochrome image data. In response, in the present exemplary embodiment, a form will been described in which a high-frequency emphasis process is performed on luminance information of color image data. By this process, it is possible to reduce the decrease in the resolution quality due to the processing according to the second exemplary embodiment. In the following, points specific to the present exemplary embodiment are mainly described.

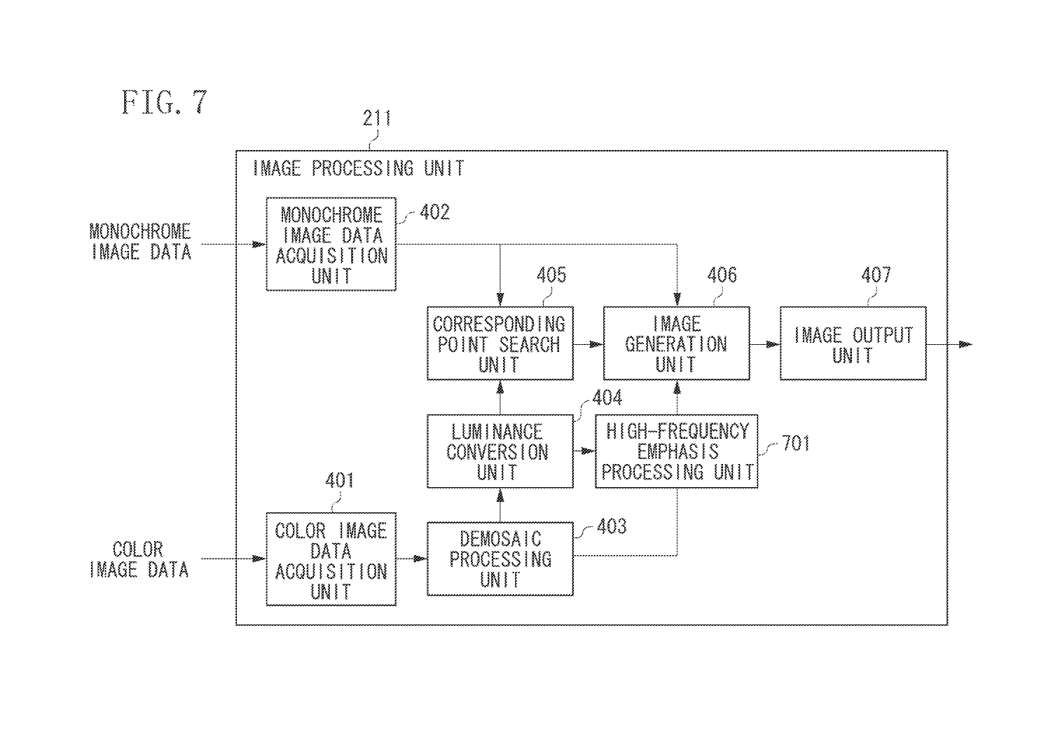

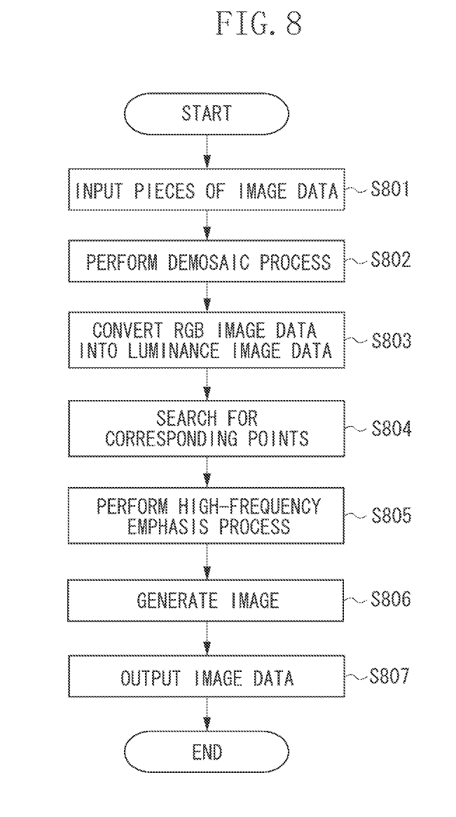

FIG. 7 is a block diagram illustrating the configuration of the image processing unit 211 according to the present exemplary embodiment. This configuration is obtained by adding a high-frequency emphasis processing unit 701 to the image processing unit 211 according to the first and second exemplary embodiments illustrated in FIG. 4. The high-frequency emphasis processing unit 701 performs the process of emphasizing a high-frequency component of luminance image data of color image data supplied from the luminance conversion unit 404. Next, with reference to a flow chart in FIG. 8, an image processing method performed by the image processing unit 211 according to the present exemplary embodiment is described. The processes from the input of pieces of image data in step S801 to the search for corresponding points in step S804 are similar to those of steps S501 to S504 in the flow chart in FIG. 5, and therefore are not described here.

In step S805, the high-frequency emphasis processing unit 701 performs the process of emphasizing a high-frequency component of the luminance image data of the color image data supplied from the luminance conversion unit 404. In step S805, the high-frequency emphasis processing unit 701 performs the process of emphasizing by a filtering process the high-frequency range of the luminance image data Yc(i,j), which is obtained from the color image data. In the present exemplary embodiment, the high-frequency emphasis processing unit 701 performs a filtering process using unsharp masking in the real space, thereby achieving a high-frequency emphasis process. Alternatively, the high-frequency emphasis processing unit 701 may perform the two-dimensional Fourier transform on the luminance image data, and then perform a filtering process for emphasizing a high-frequency component in the frequency space. Either type of processing may be employed so long as the processing emphasizes the high-frequency range of image data.

Next, in step S806, based on the relationships between the corresponding points supplied from the corresponding point search unit 405, the image generation unit 406 generates new color image data using the luminance image data generated by the high-frequency emphasis processing unit 701 and the luminance image data of the monochrome image data. This process is similar to that of the second exemplary embodiment, except that the luminance image data of the color image data subjected to high-frequency emphasis is used, and therefore is not described here.

Finally, in step S807, the image output unit 407 outputs the newly generated color image data. Thus, the image processing performed by the image processing unit 211 is completed.

The corresponding point search unit 405 according to the present exemplary embodiment searches for a corresponding point in color image data corresponding to that in monochrome image data, using luminance information of the color image data before being subjected to high-frequency emphasis. Alternatively, the corresponding point search unit 405 may search for a corresponding point using luminance information of the color image data subjected to high-frequency emphasis.

As described above, according to the present exemplary embodiment, composite image data is generated using color image data of which luminance information has been subjected to a high-frequency emphasis process, whereby it is possible to obtain color image data in which noise is suppressed while the deterioration of the resolution quality is reduced.

A fourth exemplary embodiment is described. In the first to third exemplary embodiments, a stereo imaging apparatus has been described in which a single color image capture unit and a single monochrome image capture unit are arranged as illustrated in FIG. 1. However, the arrangement and the numbers of color image capture units and monochrome image capture units are not limited to this.

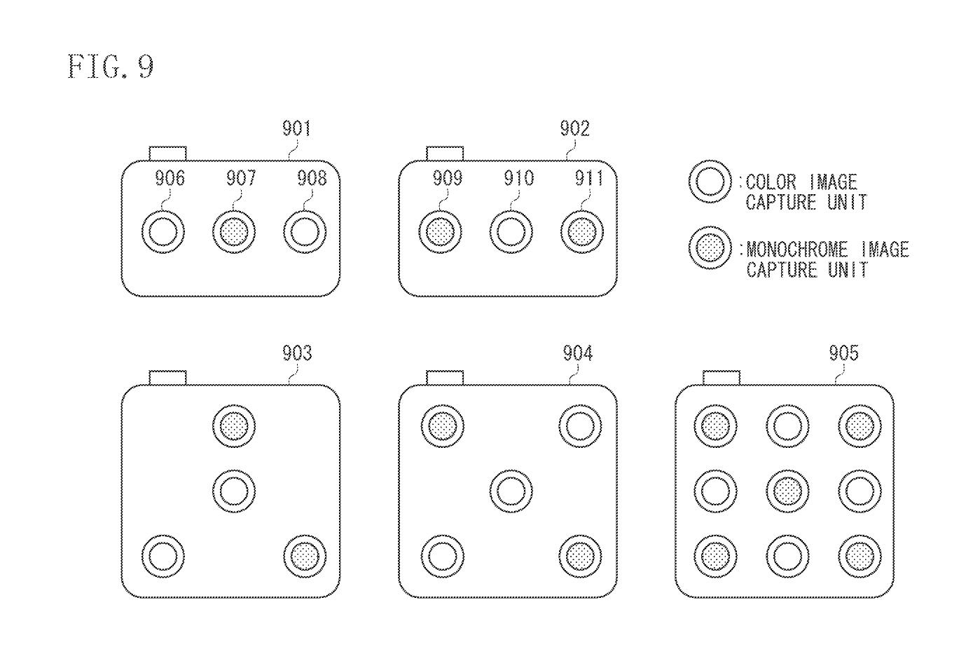

For example, as illustrated in an imaging apparatus 901 in FIG. 9, the number of color image capture units may be increased. If the number of color image capture units is thus increased, it is possible to obtain color information of an object in which noise is further suppressed.

Alternatively, as illustrated in an imaging apparatus 902, the number of monochrome image capture units may be increased. If the number of monochrome image capture units is thus increased, it is possible to obtain image data of an object with a higher resolution quality. Yet alternatively, as illustrated in imaging apparatuses 903 to 905, a multi-lens configuration with further increased numbers of color image capture units and monochrome image capture units may be used. As described above, the numbers of image capture units are increased, whereby it is possible to obtain image data of an object with a higher resolution quality in which noise is further suppressed.

In the present exemplary embodiment, the processing performed by an imaging apparatus is described using as an example a tri-lens imaging apparatus including a single color image capture unit and two monochrome image capture units as illustrated in the imaging apparatus 902. The configuration of an image processing unit according to the present exemplary embodiment is similar to the configuration of the image processing unit 211 illustrated in FIG. 2, and therefore is not described here.

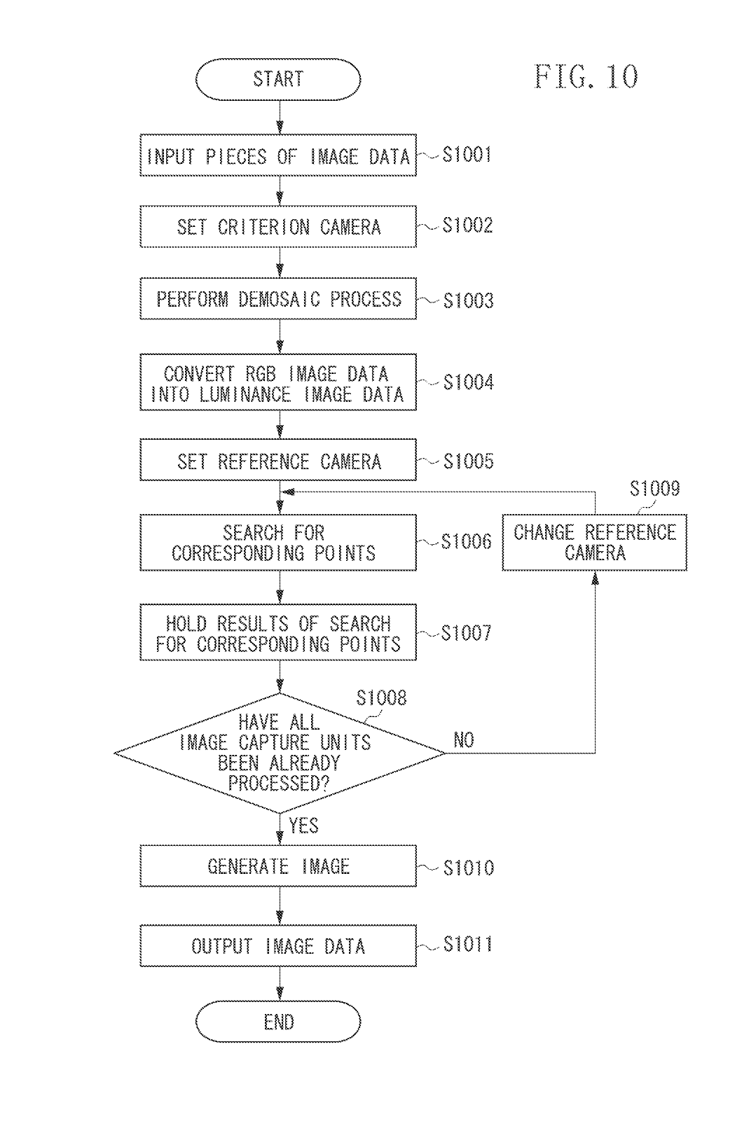

With reference to a flow chart in FIG. 10, an image processing method according to the present exemplary embodiment is described. First, in step S1001, the color image data acquisition unit 401 inputs color image data captured by a single color image capture unit 910, and the monochrome image data acquisition unit 402 inputs two pieces of monochrome image data captured by two monochrome image capture units 909 and 911. In the present exemplary embodiment, a single piece of color image data Ic(i,j), which has been captured by the color image capture unit 910, and two pieces of monochrome image data Ig(n,i,j), which have been captured by the monochrome image capture units 909 and 911, are input. In this case, n is the index of the monochrome image capture unit and takes the values of n=1, 2.

Next, in step S1002, the image processing unit 211 sets a criterion camera from among the color image capture units included in the imaging apparatus. Since a single color image capture unit is included in the present exemplary embodiment, the color image capture unit 910 is set as a criterion camera. Next, in step S1003, using the image data supplied from the color image data acquisition unit 401, the demosaic processing unit 403 generates color image data at each pixel position by an interpolation process (a demosaic process).

Next, in step S1004, the luminance conversion unit 404 converts the color image data supplied from the demosaic processing unit 403 into luminance image data. Next, in step S1005, the image processing unit 211 sets a reference camera as a target of a corresponding point search process from among the image capture units included in the imaging apparatus. In the present exemplary embodiment, the image processing unit 211 sets as a reference camera a single monochrome image capture unit from among the plurality of monochrome image capture units 909 and 911 other than the color image capture unit 910, which has been set as the criterion camera.

Next, in step S1006, the corresponding point search unit 405 searches for a corresponding point at each pixel position in the luminance image data of the color image data captured by the criterion camera and luminance image data of the monochrome image data. Next, in step S1007, the image processing unit 211 holds the results of the search performed by the corresponding point search unit 405 in the RAM 202. Next, in step S1008, the image processing unit 211 determines whether the process of searching for corresponding points in the pieces of image data acquired by all the image capture units except for the criterion camera has been completed. If there is an image capture unit of which image data has not yet been processed (NO in step S1008), the processing proceeds to step S1009.

In step S1009, the image processing unit 211 changes the reference camera and repeatedly performs the processes of steps S1006 to S1008. If the image processing unit 211 determines in step S1008 that the process of searching for corresponding points acquired by all the image capture units and corresponding to those of the criterion camera has been completed (YES in step S1008), the processing proceeds to step S1010. In step S1010, based on the relationships between the corresponding points supplied from the corresponding point search unit 405, the image generation unit 406 generates second color image data R′G′B′(i,j), which is new color image data. In the present exemplary embodiment, the image generation unit 406 converts the value of the luminance image data Yc(i,j) of the color image data acquired by the criterion camera into second luminance image data Yc′(i,j), which is new luminance image data, using formula (4).

$${Yc}^{′} ( i , j ) = \frac{{\sum }_{n = 1}^{2} Yg\_n ( x\_n ( i ) , y\_n ( j ) )}{2} \qquad ( 4 )$$

In formula (4), (x_n(i),y_n(j)) is a pixel position that is included in the monochrome image data captured by a monochrome image capture unit n and corresponds to each pixel position (i,j) in the color image data. Further, Yg_n is the luminance image data of the monochrome image data captured by the monochrome image capture unit n. In the present exemplary embodiment, it is possible to generate new luminance data from luminance information obtained from a plurality of monochrome image capture units. Thus, it is possible to generate a color image in which noise is further suppressed.

The image generation unit 406 generates color image data using the luminance data Yc′(i,j), which has been obtained by formula (4), and chromaticity information CbCr(i,j) of the color image data, which has been derived by the luminance conversion unit 404.

Finally, in step S1011, the image output unit 407 outputs the generated color image data. Thus, the image processing performed by the image processing unit 211 is completed. In the present exemplary embodiment, a form has been described in which luminance information of color image data acquired by a color image capture unit set as a criterion camera is converted using luminance information of monochrome image data, thereby generating new color image data. Alternatively, a form may be used in which, as described in the second exemplary embodiment, luminance data of color image data to be generated by the image generation unit 406 is generated using both luminance information of color image data and luminance information of monochrome image data, thereby generating an image. For example, this form may use the average value or the weighted average value of luminance values corresponding to each pixel position in the color image data. Further, in the present exemplary embodiment, the imaging apparatus searches for the correspondence between each pixel position in color image data acquired by a color image capture unit set as a criterion camera and a pixel position in monochrome image data, generates color image data viewed from the viewpoint position of the color image capture unit, and outputs the generated color image data. Alternatively, the imaging apparatus may set a monochrome image capture unit as a criterion camera, generate color image data viewed from the viewpoint position of the monochrome image capture unit, and output the generated color image data. In the present exemplary embodiment, a description has been given using as an example an imaging apparatus having a tri-lens configuration in which a single color image capture unit and two monochrome image capture units are included as illustrated in the imaging apparatus 902. The image processing method according to the present exemplary embodiment described with reference to FIG. 10 is also applicable to an imaging apparatus including a plurality of color image capture units (e.g., the imaging apparatuses 901 and 903 to 905).

In the flow chart in FIG. 10, the processing flow of the image processing method performed by, as an example, the imaging apparatus 902 including a single color image capture unit as illustrated in FIG. 9 has been described. The image processing method according to the present exemplary embodiment is also applicable to the imaging apparatuses 901 and 903 to 905, each including a plurality of color image capture units as illustrated in FIG. 9. If another color image capture unit or a monochrome image capture unit is set as a criterion camera in step S1002 in FIG. 10, the present exemplary embodiment is applicable to these cases.

If a plurality of color image capture units are included, a luminance value of a color image to be generated in step S1010 may be generated using some or all of the luminance values of pieces of color image data acquired by the plurality of color image capture units.

$$\begin{matrix}{Yc}^{′} ( i , j ) = {\sum }_{n = 1}^{N} wg\_n \times Yg\_n ( x\_n ( i ) , y\_n ( j ) ) + {\sum }_{m = 1}^{M} wc\_m \times Yc\_m ( x\_m ( i ) , y\_m ( j ) ) & ( 5 ) \\ {\sum }_{n = 1}^{N} wg\_n + {\sum }_{m = 1}^{M} wc\_m = 1 & ( 6 )\end{matrix}$$

In the above formulas, (x_n(i),y_n(j)) is a pixel position that is included in the image data captured by a monochrome image capture unit n (n=1, 2, . . . , N) set as a reference camera and corresponds to a pixel position (i,j) in the image data acquired by an image capture unit set as a criterion camera. Similarly, (x_m(i),y_m(j)) is a pixel position that is included in the image data captured by a color image capture unit m (m=1, 2, . . . , M) set as a reference camera and corresponds to the pixel position (i,j) in the image data acquired by the image capture unit set as the criterion camera. Further, Yg_n is the luminance image data of the monochrome image data captured by the monochrome image capture unit n. Further, Yc_m is luminance image data to be calculated from the color image data captured by the color image capture unit m. Further, wg_n is the weight coefficient of the luminance image data Yg_n of the monochrome image data captured by the monochrome image capture unit n. Further, wc_m is the weight coefficient of the luminance image data Yc_m of the color image data captured by the color image capture unit m.

Similarly, also for CbCr values, which are chromaticity information of a color image to be generated in step S1010, CbCr values of new color image data may be generated using some or all of the CbCr values of the pieces of color image data acquired by the plurality of color image capture units. For example, CbCr′(i,j), which is CbCr values at a pixel position (i,j) in new color image data, is calculated using formula (7).

$$\begin{matrix}{CbCr}^{′} ( i , j ) = {\sum }_{m = 1}^{M} {wc}^{′} \_m \times CbCr\_m ( x\_m ( i ) , y\_m ( j ) ) & ( 7 ) \\ {\sum }_{m = 1}^{M} {wc}^{′} \_m = 1 & ( 8 )\end{matrix}$$

In formula (7), CbCr m(i,j) is CbCr values at a pixel position (i,j) in the color image data captured by the color image capture unit m. In formula (8), wc′_m is the weight coefficient of the CbCr values of the color image data captured by the color image capture unit m. As described above, if a plurality of color image capture units are included, not only a luminance value but also chromaticity information of a color image to be generated in step S1010 may be generated using some or all of the pieces of chromaticity information of pieces of color image data acquired by the plurality of color image capture units.

As described above, according to the present exemplary embodiment, a multi-lens imaging apparatus including a plurality of color image capture units or monochrome image capture units is used, and some or all of a plurality of pieces of image data acquired by the image capture units are used, whereby it is possible to obtain color image data in which noise is further suppressed.

A fifth exemplary embodiment is described. In the first to fourth exemplary embodiments, a form has been described in which color image data of an object is generated from image data obtained by a color image capture unit and a monochrome image capture unit, and the generated color image data is output. As the fifth exemplary embodiment, a form will be described below in which color three-dimensional image data is generated by adding distance information of an object to color image data, and the generated color three-dimensional image data is output. In the following, points specific to the present exemplary embodiment are mainly described. For ease of description, in the present exemplary embodiment, a stereo imaging apparatus including a single color image capture unit and a single monochrome image capture unit as illustrated in FIG. 1 is described.

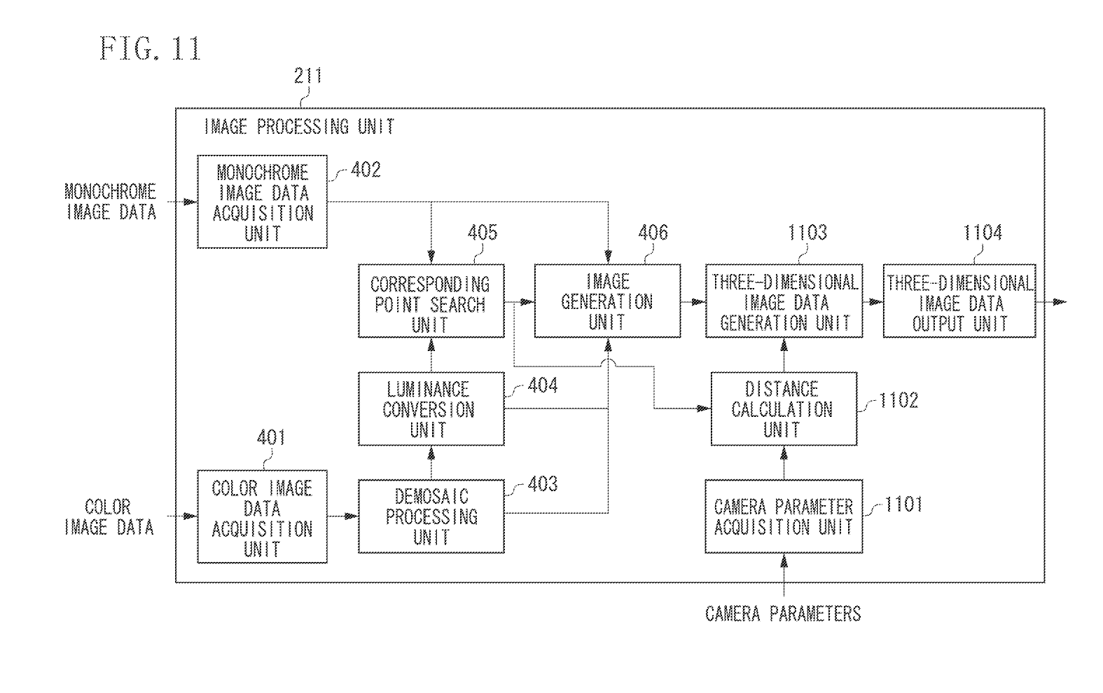

FIG. 11 is a block diagram illustrating the configuration of the image processing unit 211 according to the present exemplary embodiment. This configuration is obtained by adding a camera parameter acquisition unit 1101, a distance calculation unit 1102, and a three-dimensional image data generation unit 1103 to the image processing unit 211 according to the first exemplary embodiment illustrated in FIG. 4, and changing the image output unit 407 to a three-dimensional image data output unit 1104.

The camera parameter acquisition unit 1101 acquires camera parameters such as the focal length of a lens, the distance between the image capture units, the sensor size, the number of pixels of the sensor, and the pixel pitch of the sensor, which are related to the imaging apparatuses illustrated in FIGS. 1 and 9. Using the relationships between corresponding points at respective pixel positions in the acquired images supplied from the corresponding point search unit 405 and the camera parameters supplied from the camera parameter acquisition unit 1101, the distance calculation unit 1102 calculates the distance between objects at the respective pixel positions. The three-dimensional image data generation unit 1103 associates the distance information of the object calculated by the distance calculation unit 1102 with a pixel position in the color image data of the object generated by the image generation unit 406, thereby generating color three-dimensional image data of the object. The three-dimensional image data output unit 1104 outputs the three-dimensional image data of the object generated by the three-dimensional image data generation unit 1103.

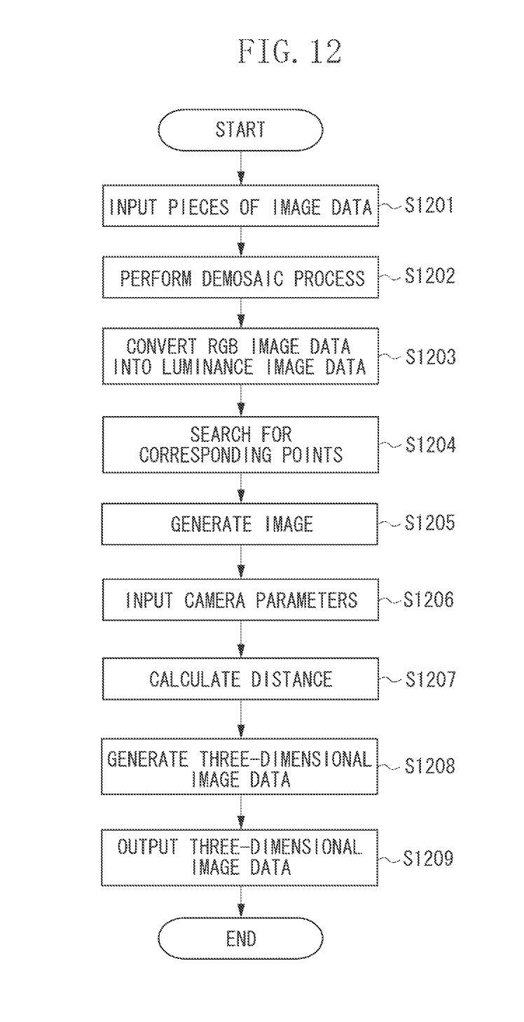

Next, with reference to a flow chart in FIG. 12, an image processing method performed by the image processing unit 211 is described. The processes from an image data input process in step S1201 to an image generation process in step S1205 are similar to those of steps S501 to S505 in the image processing method according to the first exemplary embodiment described with reference to FIG. 5, and therefore are not described here.

After the process of step S1205 has been completed, then in step S1206, the camera parameter acquisition unit 1101 acquires camera parameters such as the focal length of a lens, the distance between the image capture units, the sensor size, the number of pixels of the sensor, and the pixel pitch of the sensor, which are related to the imaging apparatus. Next, in step S1207, using the relationships between corresponding points at respective pixel positions in the acquired images supplied from the corresponding point search unit 405 and the camera parameters supplied from the camera parameter acquisition unit 1101, the distance calculation unit 1102 calculates the distance between objects at the respective pixel positions. The method for calculating the distance will be described later. Next, in step S1208, the three-dimensional image data generation unit 1103 associates the distance information of the object calculated in step S1207 with a pixel position in the color image data of the object generated in step S1205, thereby generating color three-dimensional image data of the object. Finally, in step S1209, the three-dimensional image data output unit 1104 outputs the three-dimensional image data of the object generated in step S1207. Thus, the image processing performed by the image processing unit 211 is completed.

### <Calculation of Distance Information>

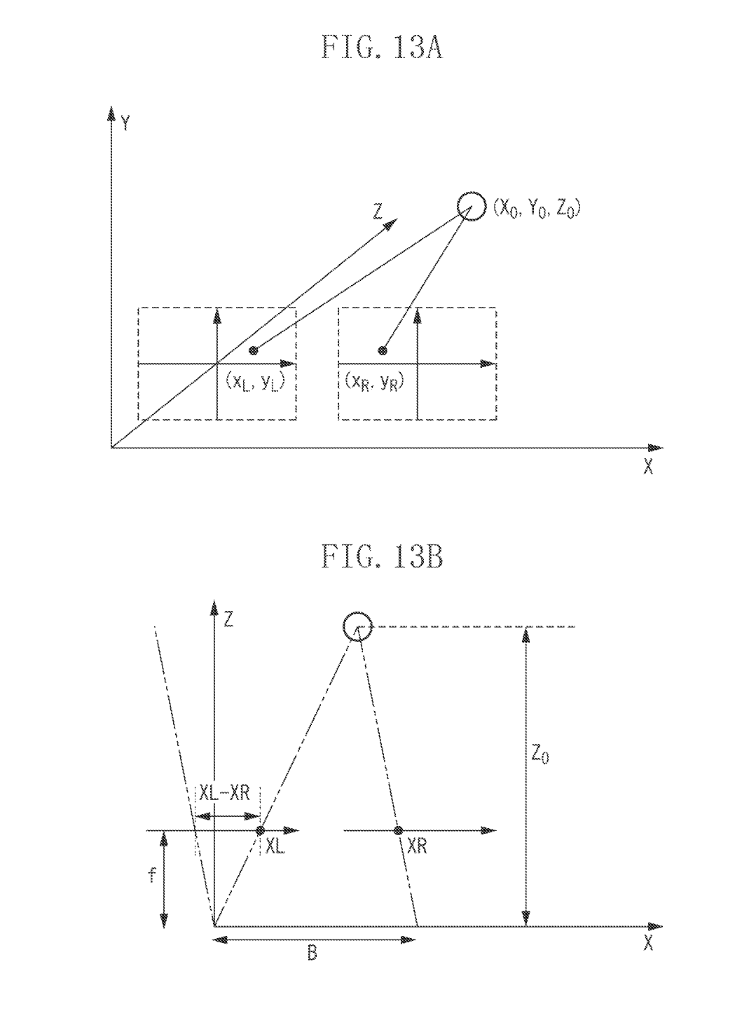

The process of calculating distance information in step S1207 is described in detail. A method for calculating distance information from pieces of photographed data photographed by two cameras (cameras 1 and 2) as illustrated in FIG. 13A is considered. In this case, coordinate axes are set such that the optical axis of the camera 1 coincides with a Z-axis. Further, the optical axes of the cameras 1 and 2 are parallel to each other and arranged parallel to an X-axis. FIG. 13B is a diagram obtained by projecting FIG. 13A onto the XZ plane. When the focus of the camera 1 is the origin of the three-dimensional space, the coordinates of a certain point of an object are (X_{O},Y_{O},Z_{O}). Further, when the center of an image photographed by the camera 1 is the origin of the two-dimensional coordinate system of the image photographed by the camera 1, the coordinates of the point where the certain point of the object forms an image on the image photographed by the camera 1 are (x_{L},Y_{L}). Further, when the center of an image photographed by the camera 2 is the origin of the two-dimensional coordinate system of the image photographed by the camera 2, the coordinates of the point where the certain point of the object (a corresponding point) forms an image on the image photographed by the camera 2 are (x_{R},y_{R}). At this time, the following formula (9) holds.

|x_{L}−x_{R}|:f=BLZ_{O} (9)

In formula (9), f is the focal length of the cameras, and B is the distance between the optical axes of the two cameras. In the geometric conditions illustrated in FIGS. 13A and 13B, the cameras 1 and 2 are arranged parallel to the X-axis, and therefore, y_{L}=y_{R}. Further, since x_{L}≧x_{R} at all times, formula (9) is deformed, whereby it is possible to obtain a distance Z_{O} between the sensor of the camera 1 or 2 and the object by the following formula (10).

$${Z}_{0} = \frac{B \cdot f}{{x}_{L} - {x}_{R}} \qquad ( 10 )$$

Further, it is possible to calculate (X_{O},Y_{O},Z_{O}) by the following formula (11), using the calculated distance information Z_{O}.

$$( {X}_{0} , {Y}_{0} , {Z}_{0} ) = ( \frac{{Z}_{0}}{f} \cdot {x}_{L} , \frac{{Z}_{0}}{f} \cdot {y}_{L} , \frac{B \cdot f}{{x}_{L} - {x}_{R}} ) \qquad ( 11 )$$

As described above, according to the process of step S1207, it is possible to calculate the distance between a sensor of a camera and an object at each pixel using the results of the search for corresponding points calculated in step S1205. That is, it is possible to calculate depth information of the object. In the present exemplary embodiment, a stereo imaging apparatus has been described in which a single color image capture unit and a single monochrome image capture unit are arranged. However, the arrangement and the numbers of color image capture units and monochrome image capture units are not limited to this.

Further, in the present exemplary embodiment, color three-dimensional image data may be generated from all the viewpoint positions of a color image capture unit and a monochrome image capture unit, and the generated color three-dimensional image data may be output. Alternatively, color three-dimensional image data may be generated from only some of the viewpoint positions, and the generated color three-dimensional image data may be output. Yet alternatively, in addition to the generated color three-dimensional image data, part or all of the monochrome image data and the color image data acquired by the monochrome image data acquisition unit 402 and the color image data acquisition unit 401 may be output. As described above, according to the present exemplary embodiment, distance information of an object is calculated, whereby it is possible to obtain color three-dimensional image data with a high resolution quality and with little noise.

In the present exemplary embodiment, the distance calculation unit 1102 functions as a distance acquisition unit configured to, based on the groups of corresponding pixels determined by the determination unit, acquire distance information indicating a distance from the object. Further, the three-dimensional image data generation unit 1103 functions as a three-dimensional (3D) generation unit configured to generate three-dimensional image data of the object using the distance information and the composite image data.

### OTHER EXEMPLARY EMBODIMENTS

The exemplary embodiments of the present disclosure are not limited to the above exemplary embodiments, and can employ various forms. For example, the above exemplary embodiments may be combined together. The configuration may be such that the third and fourth exemplary embodiments are combined together, thereby combining a plurality of pieces of color image data subjected to a high-frequency emphasis process.

Further, the present disclosure can be achieved also by performing the following process. That is, a storage medium having recorded thereon a program code of software for achieving the functions of the above exemplary embodiments is supplied to a system or an apparatus, and a computer (or a CPU or a microprocessor unit (MPU)) of the system or the apparatus reads the program code stored on the storage medium. In this case, the program code read from the storage medium achieves the functions of the above exemplary embodiments, and the program code and the storage medium having stored thereon the program code constitute the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-074571 filed Mar. 31, 2014, which is hereby incorporated by reference herein in its entirety.

What is claimed is:

1. An image processing apparatus comprising:
a first acquisition unit configured to acquire color image data including chromaticity information of an object;
a second acquisition unit configured to acquire monochrome image data including brightness information of the object; and
a generation unit configured to align and combine the color image data and the monochrome image data, thereby generating composite image data, which is image data in color and higher in resolution quality than the color image data,
wherein the generation unit generates the composite image data such that a pixel value of each pixel in the composite image data includes chromaticity information based on the color image data and brightness information based on the monochrome image data.

2. The image processing apparatus according to claim 1, wherein the generation unit generates the composite image data such that a brightness value, which is a value indicating a brightness of the object, of each pixel in the composite image data is a brightness value indicated by a corresponding pixel in the monochrome image data.

3. The image processing apparatus according to claim 1, wherein the generation unit generates the composite image data such that a brightness value, which is a value indicating a brightness of the object, of each pixel in the composite image data is an average value of a brightness value indicated by a corresponding pixel in the monochrome image data and a brightness value indicated by a corresponding pixel in the color image data.

4. The image processing apparatus according to claim 3, wherein the generation unit generates the composite image data such that the brightness value of each pixel in the composite image data is a weighted average value of a brightness value indicated by a corresponding pixel in the monochrome image data and a brightness value indicated by a corresponding pixel in the color image data.

5. The image processing apparatus according to claim 1, further comprising a processing unit configured to perform a high-frequency emphasis process for emphasizing a high-frequency component, on a brightness value of each pixel in the color image data,
wherein the generation unit generates the composite image data such that a brightness value of each pixel in the composite image data is an average value of a brightness value indicated by a corresponding pixel in the monochrome image data and a brightness value indicated by a corresponding pixel in the color image data subjected to the high-frequency emphasis process by the processing unit.

6. The image processing apparatus according to claim 5, wherein the generation unit generates the composite image data such that the brightness value of each pixel in the composite image data is a weighted average value of a brightness value indicated by a corresponding pixel in the monochrome image data and a brightness value indicated by a corresponding pixel in the color image data subjected to the high-frequency emphasis process by the processing unit.

7. The image processing apparatus according to claim 1, wherein a brightness value is a luminance value.

8. The image processing apparatus according to claim 1, wherein a brightness value is a lightness value.

9. The image processing apparatus according to claim 1, further comprising an extraction unit configured to extract brightness information of the object from the color image data,
wherein a determination unit performs the alignment by comparing brightness information of the color image data extracted by the extraction unit with brightness information of the monochrome image data.

10. The image processing apparatus according to claim 1, further comprising a distance acquisition unit configured to, based on a result of the alignment, acquire distance information indicating a distance from the object.

11. The image processing apparatus according to claim 10, further comprising a three-dimensional (3D) generation unit configured to generate three-dimensional image data of the object using the distance information and the composite image data.

12. An imaging apparatus having functions of the image processing apparatus according to claim 1, the imaging apparatus comprising:
a first image capture unit configured to capture the color image data; and
a second image capture unit configured to capture the monochrome image data.

13. An image processing method comprising:
acquiring color image data including chromaticity information of an object;
acquiring monochrome image data including brightness information of the object; and
aligning and combining the color image data and the monochrome image data, thereby generating composite image data, which is image data in color and higher in resolution quality than the color image data,
wherein in the generation, the composite image data is generated such that a pixel value of each pixel in the composite image data includes chromaticity information based on the color image data and brightness information based on the monochrome image data.

14. A non-transitory computer-readable medium having stored thereon a program for causing a computer to perform a method comprising:
acquiring color image data including chromaticity information of an object;
acquiring monochrome image data including brightness information of the object; and
aligning and combining the color image data and the monochrome image data, thereby generating composite image data, which is image data in color and higher in resolution quality than the color image data,
wherein in the generation, the composite image data is generated such that a pixel value of each pixel in the composite image data includes chromaticity information based on the color image data and brightness information based on the monochrome image data.
